(19) United States
(12) Patent Application Publication
(10) Pub. No.: US 2025/0077968 A1
(43) Pub. Date: Mar. 6, 2025

(54) LEARNING SYSTEM, LEARNING METHOD, AND LEARNING PROGRAM

(71) Applicant: MIZUHO RESEARCH & TECHNOLOGIES, LTD., Tokyo (JP)

(72) Inventors: Takeshi NAGATA, Tokyo (JP); Kosuke TAKEDA, Tokyo (JP); Hidemasa MAEKAWA, Tokyo (JP); Chihiro SEKO, Tokyo (JP); Hiroshi KOIZUMI, Tokyo (JP); Makiko SUITANI, Tokyo (JP); Yuya NEMOTO, Tokyo (JP); Daiki HASHIMOTO, Tokyo (JP); Yuji MORI, Tokyo (JP); Yuki TAMAGAKI, Tokyo (JP); Kohei IWABUCHI, Tokyo (JP); Kenta KONAGAYOSHI, Tokyo (JP); Taishi SHINOBU, Tokyo (JP)

(21) Appl. No.: 18/727,278

(22) PCT Filed: Dec. 26, 2022
(86) PCT No.: PCT/JP2022/047954

§ 371 Date: Jul. 8, 2024

(30) Foreign Application Priority Data
Jan. 11, 2022 (JP) 2022-002464

(51) Int. Cl. G06N 20/00; G06N 5/022

(52) U.S. Cl. CPC G06N 20/00; G06N 5/022

(57) ABSTRACT

A control unit of a support server identifies, with respect to input data, a nearby node among existing nodes. The control unit calculates the distance between the input data and the nearby node. If the distance is greater than a maximum distance, the control unit uses the input data to add a new node to the existing nodes, and updates the activity value and the age of the new node and the nearby node in accordance with the distance to the nearby node. The control unit generates a self-organizing map by using the activity value of each node and the activity value of each path to calculate an age-based degree of activity, and by determining the presence or absence of each node and each path according to the degree of activity.

### TECHNICAL FIELD

The present disclosure relates to a learning system, a learning method, and a learning program that generate a self-organizing map.

### BACKGROUND ART

Machine learning may use self-organizing maps (SOMs) (see Patent Literature 1, for example). The self-organizing map, which is a model proposed by Kohonen, can map piece of input data into any dimension through unsupervised learning. The self-organizing map uses Hebb's rule. According to Hebb's rule, when two neurons repeatedly fire simultaneously, the efficiency of synaptic transmission between the neurons is enhanced. Conversely, when simultaneous firing does not occur for a long period of time, the transmission efficiency of that synapse decreases. In other words, Hebb's rule is a law in which pathways important for information processing are strengthened while unnecessary pathways are eliminated.

A technique called evolving self-organizing map (ESOM: Evolving SOM) has also been contemplated as a learning technique that increments neurons as needed during learning (see Non-Patent Literature 1). Furthermore, self-organizing incremental neural network (SOINN) has also been contemplated (see Non-Patent Literature 2, for example). SOINN is an online unsupervised learning technique achieved by extending growing neural gas (GNG) and a self-organizing map (SOM) and supports incremental learning. Specifically, SOINN forms a network in a self-organizing manner for input data that is obtained online from distributions having non-stationary, complex shapes that dynamically change, and outputs phase structures of the appropriate number of classes and input data distribution.

### CITATION LIST

### Patent Literature

Patent Literature 1: Japanese Laid-Open Patent Publication No. 2008-250848

### Non-Patent Literature

Non-Patent Literature 1: Tetsuo Furukawa, “Introduction of Self-Organizing Map”,

Kyushu Institute of Technology, [online], Jun. 3, 2017, [Retrieved Nov. 12, 2021], Internet <URL: http://www.brain.kyutech.ac.jp/˜furukawa/data/SOMtext.pdf>
Non-Patent Literature 2: Takuya Fukatsu et al., “What is SOINN?”, Intelligence and Information, Journal of the Japanese Society for Fuzzy Theory and Intelligent Informatics, Vol. 30, No. 2, pp. 98-105, [Retrieved Nov. 12, 2021], Internet <URL: https://www.jstage.jst.go.jp/article/jsoft/30/2/30_98/_pdf>

### SUMMARY OF INVENTION

### Technical Problem

However, the ESOM learning process does not have a function of removing nodes and is therefore susceptible to noise (isolated points). Also, the results of the ESOM learning process can vary greatly depending on the parameters (path removal intervals), and necessary paths would be removed. This increases the difficulty in adjustment.

### Solution to Problem

In one general aspect, a learning system includes a control unit that creates a self-organizing map. The control unit is configured to identify a neighboring node for a piece of input data among existing nodes, calculate a distance between the piece of input data and the neighboring node. The control unit is also configured to, when the distance is greater than a maximum distance, add a new node to the existing nodes using the piece of input data and update activation values and ages of the new node and the neighboring node in accordance with the distance to the neighboring node. The control unit is also configured to, when the distance is less than or equal to the maximum distance, update a position, an activation value, and an age of the neighboring node in accordance with the distance between the piece of input data and the neighboring node. The control unit is further configured to calculate an activation rate from the age using an activation value of each node and an activation value of each path and create the self-organizing map by determining presence or absence of each node and each path in accordance with the calculated activation rate.

### BRIEF DESCRIPTION OF DRAWINGS

FIG. 1 is an explanatory diagram of a learning system according to a first embodiment.

FIG. 2 is an explanatory diagram of the hardware configuration of the first embodiment in the learning system shown in FIG. 1.

FIG. 3 is an explanatory diagram of the process procedure for of the first embodiment in the learning system shown in FIG. 1.

FIG. 4 is an explanatory diagram of a process procedure of the first embodiment in the process procedure shown in FIG. 3.

FIG. 5 is an explanatory diagram of a distance table of the first embodiment in the process procedure shown in FIG. 4.

FIG. 6 is an explanatory diagram of a process procedure of the first embodiment in the process procedure shown in FIG. 3.

FIG. 7 is an explanatory diagram of a process procedure of the first embodiment in the process procedure shown in FIG. 6.

FIG. 8 is an explanatory diagram of a process procedure of the first embodiment in the process procedure shown in FIG. 6.

FIG. 9 is an explanatory diagram of a process procedure of the first embodiment in the process procedure shown in FIG. 3, in which part (a) illustrates arrangement of piece of input data, part (b) illustrates addition of a new node, and part (c) illustrates update of existing nodes.

FIG. 10 is an explanatory diagram of piece of input data of the first embodiment for the process procedure shown in FIG. 3.

FIG. 11 is an explanatory diagram of a comparative example in which the path removal interval is changed in the ESOM, in which part (a) corresponds to a path removal interval of 20 steps, part (b) corresponds to 30 steps, and part (c) corresponds to 40 steps.

FIG. 12 is an explanatory diagram of a situation where the number of pieces of node neighboring data is changed in the first embodiment obtained in the process procedure shown in FIG. 3, in which the number of pieces of neighboring data is 40 in part (a), 50 in part (b), and 60 in part (c).

FIG. 13 is an explanatory diagram of a process procedure according to a second embodiment.

FIG. 14 is an explanatory diagram of a process procedure according to a third embodiment.

FIG. 15 is an explanatory diagram of a modification a process procedure different from the process procedure shown in FIG. 14.

FIG. 16 is an explanatory diagram of a process procedure of a comparative example.

FIG. 17 is an explanatory diagram of a process procedure of a comparative example in the process procedure shown in FIG. 16, in which part (a) illustrates arrangement of piece of input data, part (b) illustrates addition of a new node, and part (c) illustrates update of existing nodes.

### DESCRIPTION OF EMBODIMENTS

In this specification, “at least one of A and B” should be understood to mean “only A, only B, or both A and B.” First Embodiment

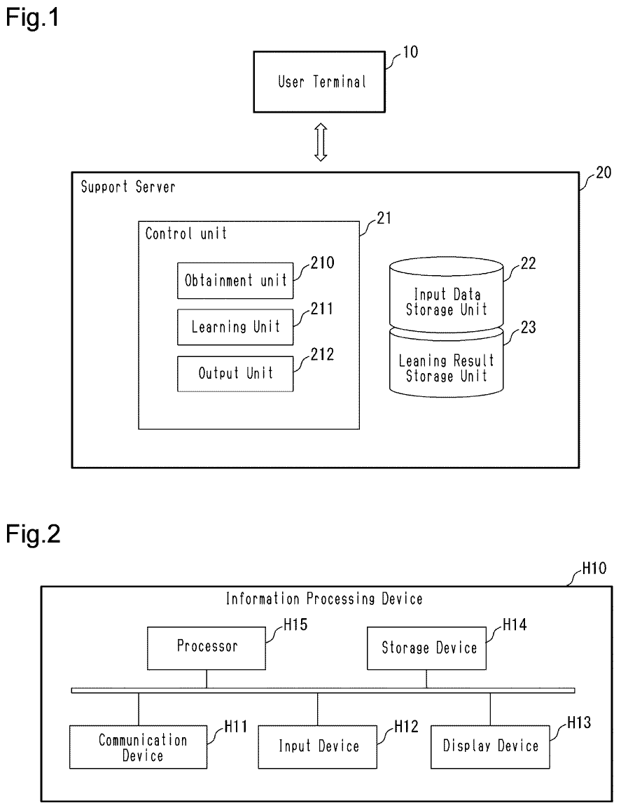

Referring to FIGS. 1 to 12, a learning system, a learning method, and a learning program according to an embodiment will now be described. The present embodiment describes a situation in which a self-organizing map is created online (in real time). The concept of “age” is introduced for paths and nodes, and nodes and paths whose activation rate (activation value/age) is less than or equal to a threshold are removed.

As shown in FIG. 1, the learning system of this embodiment uses a user terminal 10 and a support server 20.

### Hardware Configuration Example

FIG. 2 is an example of the hardware configuration of an information processing device H10, which functions as the user terminal 10, the support server 20, or the like.

The information processing device H10 includes a communication device H11, an input device H12, a display device H13, a storage device H14, and a processor H15. This hardware configuration is merely an example, and the information processing device H10 may include other hardware.

The communication device H11 is an interface, such as a network interface or a wireless interface, which establishes communication paths with other devices and performs data transmission/reception.

The input device H12 receives input from a user or the like and may be a mouse or a keyboard, for example. The display device H13 may be a display, a touch panel, or the like that displays various information.

The storage device H14 stores data and various programs for executing various functions of the user terminal 10 or the support server 20. Examples of the storage device H14 include ROM, RAM, and hard disk.

The processor H15 controls processes of the user terminal 10 or the support server 20 (for example, the process of a control unit 21 described below) using programs and data stored in the storage device H14. Examples of the processor H15 include a CPU and an MPU. The processor H15 loads the programs stored in the ROM or the like into the RAM and performs various processes corresponding to various types of processing. For example, when the application program of the user terminal 10 or the support server 20 is started, the processor H15 starts a process for performing various types of processing described below.

The processor H15 is not limited to one that performs software processing on all processes executed by itself. For example, the processor H15 may include a dedicated hardware circuit (for example, an application specific integrated circuit: ASIC) that executes at least part of the processes executed by itself. More specifically, the processor H15 may be any of the following.
(1) One or more processors running on computer programs (software).
(2) One or more special-purpose hardware circuits that executes at least some of the processes.
(3) Circuitry including a combination of the above elements.

The processor includes a CPU and a memory such as a RAM and a ROM. The memory stores program codes or instructions configured to cause the CPU to execute processes. Memory or computer-readable media includes any available media that can be accessed by a general purpose or special purpose computer.

### Functions of Information Processing Devices

Referring to FIG. 1, the functions of the user terminal 10 and the support server 20 are now described.

The user terminal 10 is a computer terminal used by a user of this system.

The support server 20 is a computer system, which creates a self-organizing map. The support server 20 includes a control unit 21, an input data storage unit 22, and a learning result storage unit 23.

The control unit 21 performs the processes described below (processes including an obtainment step, a learning step, an output step, and the like). The control unit 21 may function as an obtainment unit 210, a learning unit 211, and an output unit 212, for example, by executing a learning program for the above processes.

The obtainment unit 210 performs a process of obtaining input data from the user terminal 10.

The learning unit 211 performs a process of creating a self-organizing map. The output unit 212 performs a process of outputting a self-organizing map. The input data storage unit 22 records information (input data) to be used to create

a self-organizing map. This input data is recorded in the input data storage unit 22 when data to be used to create a self-organizing map is obtained. Input data includes vectors including multiple pieces of element data having different dimensions.

The learning result storage unit 23 records the self-organizing map. The self-organizing map is recorded as the learning process is performed. As the self-organizing map, the learning result storage unit 23 stores a map including nodes arranged in a multi-dimensional space and paths connecting the nodes. Each of the paths and nodes has information regarding age. The age is incremented by 1 when a new piece of input data is obtained. Each of the paths and nodes also has information regarding its activation value. The activation value is an index representing the effectiveness (significance of existence) of each path and node.

The learning result storage unit 23 also stores a maximum distance dmax between nodes. This maximum distance dmax is used to determine whether a new node needs to be created.

Furthermore, the learning result storage unit 23 stores a node removal threshold and a path removal threshold. The node removal threshold and the path removal threshold are used to determine the presence or absence of a node or a path when updating the self-organizing map.

### Map Creation Process

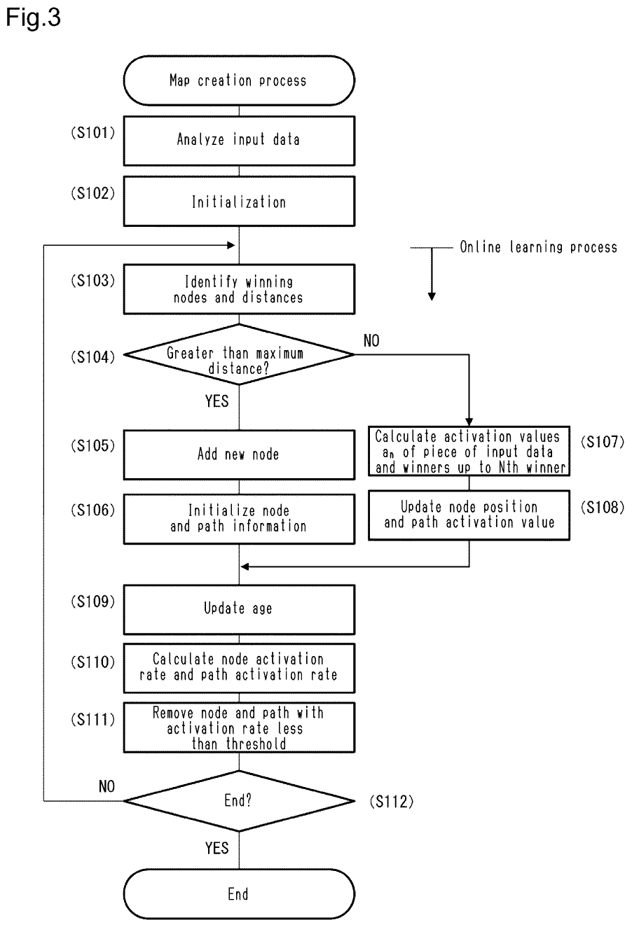

Referring to FIG. 3, a map creation process of the present embodiment is now described. In this process, the obtainment unit 210 of the control unit 21 of the support server 20 obtains input data from the user terminal 10. The obtainment unit 210 records the input data in the input data storage unit 22.

First, the control unit 21 of the support server 20 performs processing of input data analysis (step S101). Specifically, the learning unit 211 of the control unit 21 calculates the maximum distance dmax used to create a node from a piece of input data D(i). With respect to the total number N of pieces of data, the number Nn of pieces of neighboring data of a node and the number Nw of winners to be considered are set in advance.

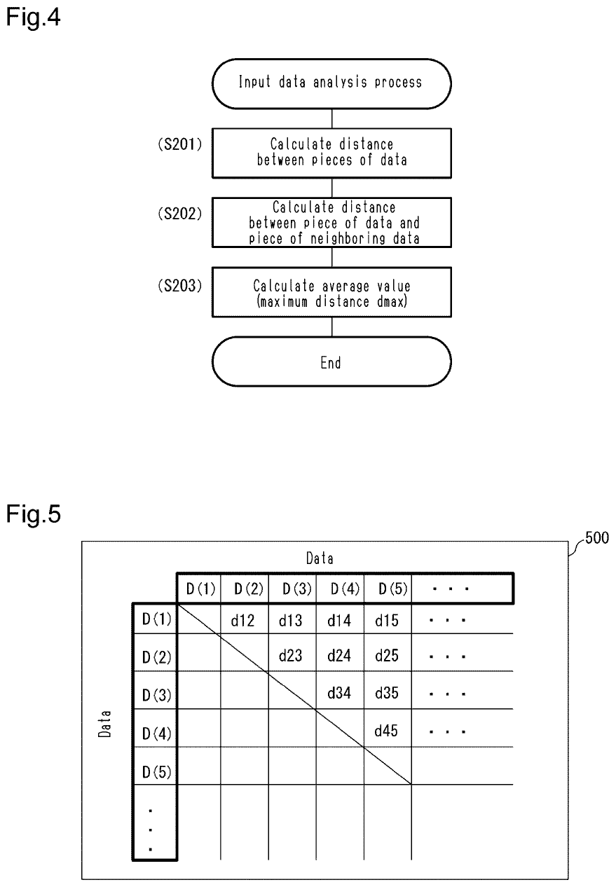

Referring to FIG. 4, the input data analysis (step S101) is described.

First, the control unit 21 of the support server 20 performs a process of calculating the distance between the pieces of input data D(i) (step S201). Specifically, the learning unit 211 of the control unit 21 calculates the distance between every combination of two pieces of input data D(i).

In this case, as shown in FIG. 5, distance table 500 is created by calculating the distances (d12, d13, . . . , d23, . . . ) between each piece of input data D(i). For example, d12 is the distance between a piece of input data D(1) and a piece of input data D(2).

The control unit 21 of the support server 20 then performs processing of calculating the distance between each piece of input data D(i) and a piece of neighboring data (step S202). Specifically, the learning unit 211 of the control unit 21 sorts the distances in distance table 500 in ascending order, and obtains the distances up to the Nn-th length.

The control unit 21 of the support server 20 then performs processing of calculating an average value (step S203). Specifically, the learning unit 211 of the control unit 21 calculates the average value (statistical value) of the obtained distances up to the Nn-th distance. The average value is recorded in the learning result storage unit 23 as the maximum distance dmax between nodes.

As shown in FIG. 3, the control unit 21 of the support server 20 then performs an initialization process (step S102). Here, the learning unit 211 of the control unit 21 determines parameters and initial nodes.

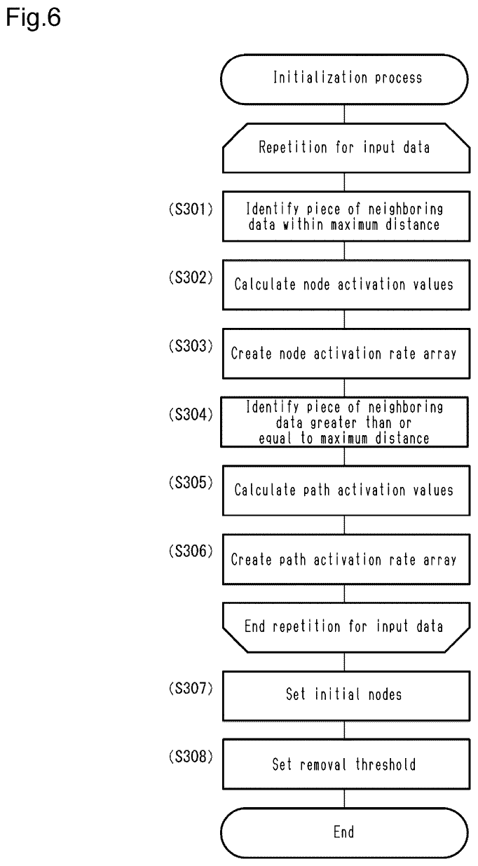

Specifically, referring to FIG. 6, the initialization process (step S102) is described. In this step, all piece of input data D(i) are treated as nodes.

First, the control unit 21 of the support server 20 repeats the following process while sequentially specifying each piece of input data D(i) as a processing target from i=1.

The control unit 21 of the support server 20 performs processing of identifying a piece of neighboring data within the maximum distance (step S301). Specifically, the learning unit 211 of the control unit 21 identifies all pieces of neighboring data whose distance from the piece of input data D(i) to be processed is within the maximum distance dmax.

The control unit 21 of the support server 20 then performs processing of node activation value calculation (step S302). Specifically, the learning unit 211 of the control unit 21 calculates the node activation value Aw(ni) of each piece of neighboring data by the following expression:

$${A}_{w} ( {n}_{i} ) = exp ( - \frac{{d}^{2}}{d {max}^{2}} ) \qquad [ Expression 1 ]$$

The control unit 21 of the support server 20 then performs processing of creating a node activation rate array (step S303). Specifically, the learning unit 211 of the control unit 21 creates [Arate_W(i)i=1 to N] in which the activation values of all nodes are arranged in a one-dimensional array. This [Arate_W(i)i=1 to N] is a one-dimensional array, and [Arate_W(i)i=1 to N] contains the activation values of all nodes. The learning unit 211 then calculates a node activation rate Arate_W(i). This node activation rate Arate_W(i) is calculated by dividing the sum of the node activation values of the piece of data within the maximum distance dmax from the node ni by the age.

The control unit 21 of the support server 20 then performs processing of identifying a piece of neighboring data having a distance greater than or equal to the maximum distance (step S304). Specifically, the learning unit 211 of the control unit 21 identifies another piece of input data D(j) whose distance from the piece of input data D(i) to be processed is greater than or equal to the maximum distance dmax.

The control unit 21 of the support server 20 then performs the step of path activation value calculation (step S305). Specifically, the learning unit 211 of the control unit 21 calculates the path activation value As (n1, n2) of each piece of neighboring data (piece of input data D(j)) by the following expression. The nodes at opposite ends of the path are a first node n1 and a second node n2. d1 is the distance between the first node n1 and the piece of data D(j), and d2 is the distance between the second node n2 and the piece of data D(j).

$${A}_{s} ( {n}_{1} , {n}_{2} ) = exp ( - \frac{{d}_{1}^{2} + {d}_{2}^{2}}{d {max}^{2}} ) \qquad [ Expression 2 ]$$

The control unit 21 of the support server 20 then performs processing of path activation rate array creation (step S306). Specifically, the learning unit 211 of the control unit 21 creates [Arate_S(i, j) i=1 to N, j=1 to N] in which the activation values of all paths are arranged in a two-dimensional array. This [Arate_S(i, j) i=1 to N, j=1 to N] is a two-dimensional array, and [Arate_S(i, j) i=1 to N, j=1 to N] includes the activation values of all paths. The learning unit 211 then calculates a path activation rate Arate_S(i, j). This path activation rate Arate_S(i, j) is obtained by dividing the sum of node activation values of piece of data belonging to the path (i, j) by the age.

The above process is repeated for all piece of input data.

The control unit 21 of the support server 20 then performs an initial node setting process (step S307).

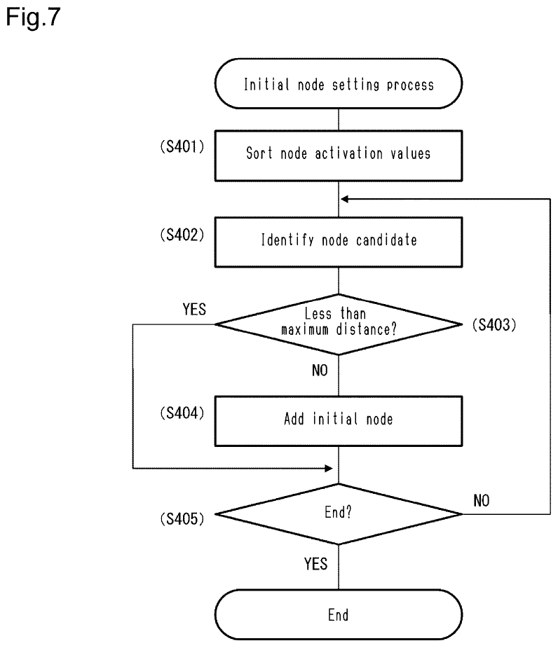

Referring to FIG. 7, the initial node setting process (step S307) is described.

First, the control unit 21 of the support server 20 performs processing of node activation rate sorting (step S401). Specifically, the learning unit 211 of the control unit 21 sorts the pieces of input data D(i) in descending order of the node activation rates Arate_W(i).

The control unit 21 of the support server 20 then performs processing of identifying a node candidate (step S402). Specifically, the learning unit 211 of the control unit 21 sequentially identifies a piece of input data D(i) with a high activation rate as a node candidate.

The control unit 21 of the support server 20 then performs processing of determining whether the distance is less than the maximum distance (step S403). Specifically, the learning unit 211 of the control unit 21 calculates the distance between the node candidate and the already registered node, and compares the calculated distance with the maximum distance dmax.

If it is determined that the distance between the node candidate and the already registered node is greater than or equal to the maximum distance (NO at step S403), the control unit 21 of the support server 20 performs processing of initial node addition (step S404). Specifically, the learning unit 211 of the control unit 21 adds the node candidate as a new node and records it in the learning result storage unit 23.

If it is determined that the distance between the node candidate and the already registered node is less than the maximum distance (YES at step S403), the control unit 21 of the support server 20 skips processing of initial node addition (step S404).

The control unit 21 of the support server 20 then performs processing of determining whether to end the process (step S405). Specifically, the learning unit 211 of the control unit 21 determines to end the process when processing has been completed for the piece of input data D(i) with the lowest activation rate.

If it is determined not to end the process (NO at step S405), the control unit 21 of the support server 20 repeats the process from the processing of identifying a node candidate (step S402).

If it is determined to end the process (YES at step S405), the control unit 21 of the support server 20 ends the initial node setting process (step S307).

Then, as shown in FIG. 6, the control unit 21 of the support server 20 performs a removal threshold setting process (step S308).

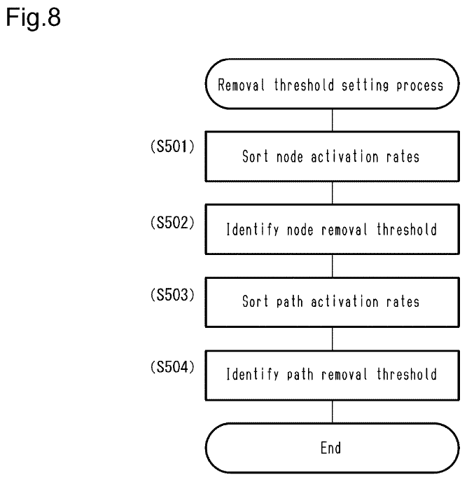

Referring to FIG. 8, the removal threshold setting process (step S308) is now described.

The control unit 21 of the support server 20 performs processing of node activation rate sorting (step S501). Specifically, the learning unit 211 of the control unit 21 sorts the node activation rates Arate_W(i) in descending order.

The control unit 21 of the support server 20 then performs processing of identifying a node removal threshold (step S502). Specifically, the learning unit 211 of the control unit 21 identifies the value of the node activation rate Arate_W(i) of a specified rank (Ndw) as the node removal threshold, and records it in the learning result storage unit 23.

The control unit 21 of the support server 20 then performs processing of sorting path activation rates (step S503). Specifically, the learning unit 211 of the control unit 21 sorts the path activation rates Arate_S(i, j) in descending order.

The control unit 21 of the support server 20 then performs processing of identifying a path removal threshold (step S504). Specifically, the learning unit 211 of the control unit 21 identifies the path activation rate Arate_S(i, j) of a specified rank (Nds) as the path removal threshold, and records it in the learning result storage unit 23.

As shown in FIG. 3, an online learning process is then performed. This process is performed when a new piece of input data D(i) is obtained online. Here, it is assumed that i=1 to M.

First, the control unit 21 of the support server 20 performs processing of identifying winning nodes and distances (step S103). Specifically, the learning unit 211 of the control unit 21 identifies N nodes (first winner to Nth winner) as neighboring nodes among the nodes (existing nodes) forming the self-organizing map recorded in the learning result storage unit 23. Here, the learning unit 211 identifies N nodes (first winner to Nth winner) in order of positional proximity to the newly obtained piece of input data D(i). Then, the learning unit 211 calculates the distance (d1 to dn) between the piece of input data D(i) and each winner (first winner to Nth winner).

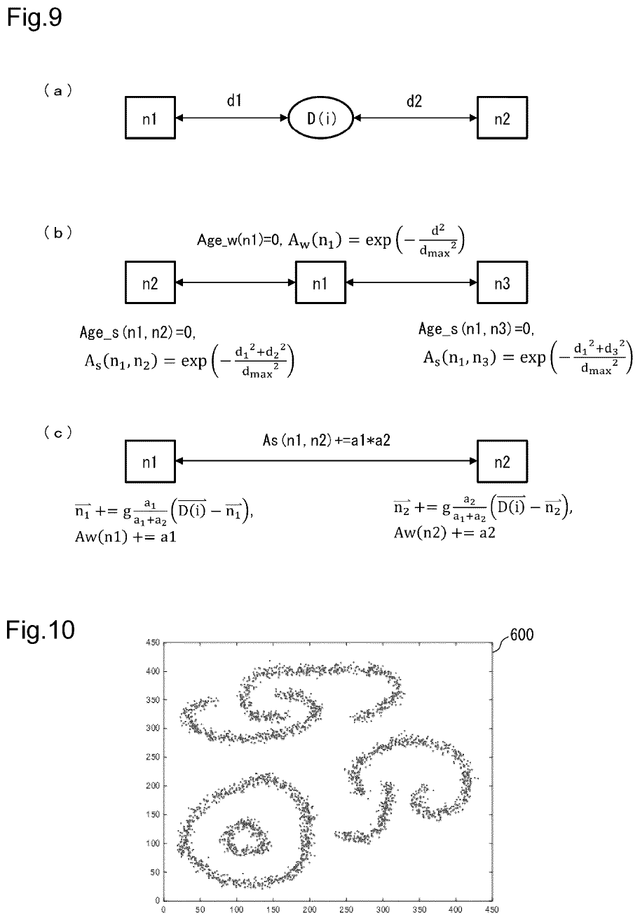

As shown in part (a) of FIG. 9, two winners (first winner n1 and second winner n2) are identified, and the distance d1, d2 to each winner (n1, n2) from the piece of input data D(i) is calculated.

The control unit 21 of the support server 20 then performs processing of determining whether the calculated distance is greater than the maximum distance (step S104). Specifically, the learning unit 211 of the control unit 21 compares the distance d1 between the newly obtained piece of input data D(i) and the closest node (n1) with the maximum distance dmax.

If the distance d1 is greater than the maximum distance dmax (YES at step S104), the control unit 21 of the support server 20 performs processing of adding a new node (step S105). Specifically, the learning unit 211 of the control unit 21 records the piece of input data D(i) in the learning result storage unit 23 as a new node.

As shown in part (b) of FIG. 9, the first and second nodes n1 and n2 become the second and third nodes n2 and n3, respectively, and the piece of input data D(i) is added as the first node n1.

The control unit 21 of the support server 20 then performs processing of node and path information initialization (step S106). Specifically, the learning unit 211 of the control unit 21 initializes the ages (Age_w, Age_s) and the activation values (Aw, As).

As shown in part (b) of FIG. 9, the information of each node is initialized using the following expression. Here, the first node n1 is initialized.

$$Age\_w ( n 1 ) = 0 \qquad [ Expression 3 ]$$

$${A}_{w} ( {n}_{1} ) = exp ( - \frac{{d}^{2}}{{d}_{max}^{2}} ) \qquad [ Expression 4 ]$$

In the expressions, d is the distance between each node ni and the first node n1.

Also, the path information of the first and second nodes n1 and n2 is updated.

$$Age\_s ( n 1 \cdot n 2 ) = 0 \qquad [ Expression 5 ]$$

$${A}_{s} ( {n}_{1} , {n}_{2} ) = exp ( - \frac{{d}_{1}^{2} + {d}_{2}^{2}}{{d}_{max}^{2}} ) \qquad [ Expression 6 ]$$

The path information of the first and third nodes n1 and n3 is also updated.

$$Age\_s ( n 1 , n 3 ) = 0 \qquad [ Expression 7 ]$$

$${A}_{s} ( {n}_{1} , {n}_{3} ) = exp ( - \frac{{d}_{1}^{2} + {d}_{3}^{2}}{{d}_{max}^{2}} ) \qquad [ Expression 8 ]$$

If the distance d1 is less than or equal to the maximum distance dmax (NO at step S104), the control unit 21 of the support server 20 performs processing of calculating the activation values an of the piece of input data and the winners up to the Nth winner (Step S107). Here, the activation values aₙ (n=1 to N) of the new node and the existing winners up to the Nth winner are determined. Specifically, the learning unit 211 of the control unit 21 calculates the activation value using the following expression.

$${a}_{n} = exp ( - \frac{{d}^{2}}{{d}_{max}^{2}} ) \qquad [ Expression 9 ]$$

In the expression, d is the distance between each node ni and the piece of input data D(i).

As shown in part (c) of FIG. 9, the control unit 21 of the support server 20 then performs processing of updating the node positions and path activation values (step S108). Specifically, the learning unit 211 of the control unit 21 updates the node position using the following expression.

$$\vec{{n}_{1}} += g \frac{{a}_{1}}{{a}_{1} + {a}_{2}} ( \vec{D ( l )} - \vec{{n}_{1}} ) \qquad [ Expression 10 ]$$

$$\vec{{n}_{2}} + = g \frac{{a}_{2}}{{a}_{1} + {a}_{2}} ( \vec{D ( l )} - \vec{{n}_{2}} )$$

In the expression, g is a coefficient representing the learning rate.

Furthermore, the learning unit 211 updates the path activation value As by the following expression.

$${A}_{s} ( {n}_{1} , {n}_{2} ) = exp ( - \frac{{d}_{1}^{2} + {d}_{2}^{2}}{{d}_{max}^{2}} ) \qquad [ Expression 11 ]$$

$${A}_{s} ( {n}_{1} , {n}_{3} ) = exp ( - \frac{{d}_{1}^{2} + {d}_{3}^{2}}{{d}_{max}^{2}} )$$

The learning unit 211 of the control unit 21 also updates the node activation value Aw using the following expression.

$$Aw ( n 1 ) += a 1 \qquad [ Expression 12 ]$$

$$Aw ( n 2 ) += a 2$$

The learning unit 211 of the control unit 21 also updates the path activation value As using the following expression.

$$As ( n 1 , n 2 ) += a 1 \times a 2 \qquad [ Expression 13 ]$$

The control unit 21 of the support server 20 then performs processing of age update (step S109). Specifically, the learning unit 211 of the control unit 21 updates the ages Age_w and Age_s of the nodes and the paths by adding 1 to the ages.

The control unit 21 of the support server 20 then performs processing of calculating node activation rates and path activation rates (step S110). Specifically, the learning unit 211 of the control unit 21 calculates the node activation rate Arate_w by the following expression.

$$Arate\_w = \frac{Aw}{Age\_w} \qquad [ Expression 14 ]$$

The learning unit 211 of the control unit 21 calculates the path activation rate Arate_s by the following expression.

$$Arate\_s = \frac{A s}{Age\_s} \qquad [ Expression 15 ]$$

The control unit 21 of the support server 20 then performs processing of removing paths and nodes whose activation rates are below the threshold (step S111). Specifically, the learning unit 211 of the control unit 21 removes nodes and paths whose activation rate is below the threshold.

The control unit 21 of the support server 20 then performs processing of determining whether to end the process (step S112). Specifically, if i=M, the learning unit 211 of the control unit 21 determines that all pieces of input data have been processed.

In this case, the online learning process ends.

If it is determined not to end the process (NO at step S112), the control unit 21 of the support server 20 sets i=i+1 and repeats the process from step S103.

The present embodiment has the following advantageous effects.
(1-1) In this embodiment, the control unit 21 of the support server 20 performs processing of input data analysis (step S101). This enables calculation of the maximum distance dmax between nodes.
(1-2) In this embodiment, the control unit 21 of the support server 20 performs an initialization process (step S102). This allows the initial node to be set taking into account the maximum distance between nodes. Also, a removal threshold can be set.
(1-3) In the present embodiment, if the distance d1 is greater than the maximum distance dmax (YES at step S104), the control unit 21 of the support server 20 performs processing of adding a new node (step S105). The control unit 21 of the support server 20 then performs processing of node and path information initialization (step S106). This allows a new node to be set according to input.
(1-4) In the present embodiment, if the distance d1 is less than or equal to the maximum distance (NO at step S104), the control unit 21 of the support server 20 performs processing of calculating the activation values an of the piece of input data and the winners up to the Nth winner (step S107). The control unit 21 of the support server 20 then performs processing of updating the node positions and path activation values (step S108). This allows for evaluation of the use status of nodes and paths.
(1-5) In this embodiment, the control unit 21 of the support server 20 performs an age update process (step S109) and a node activation rate and path activation rate calculation process (step S110). This allows for the introduction of the concept of time (age) while adopting Hebb's rule, thereby introducing activation rate (activity/age) to nodes and paths. The effectiveness of nodes and paths can be identified by the activation rate.
(1-6) In the present embodiment, the control unit 21 of the support server 20 performs processing of removing paths and nodes whose activation rates are below the threshold (step S111). This allows for removal of nodes and paths whose activation rate is less than or equal to the threshold. Thus, isolated nodes can be removed. Also, paths that do not need to be removed are not removed. As a result, stable learning is achieved with a small number of parameters. This efficiently creates an accurate self-organizing map.

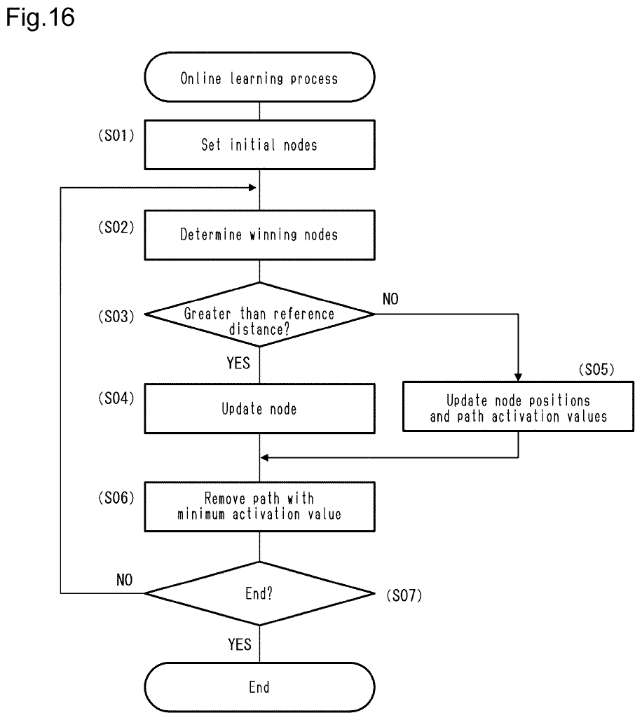

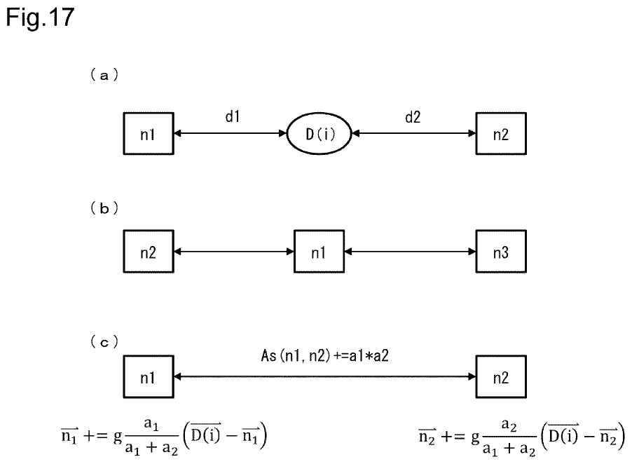

Referring to FIGS. 16 and 17, an online learning process of an evolving self-organizing map (ESOM) is described as a comparative example.

As shown in FIG. 16, initial nodes are first set (step S01). Specifically, two pieces of input data D(i) (i=1 to M) are randomly selected and set as initial nodes. In this case, data index i=1.

Winning nodes are then determined (step S02).

As shown in part (a) of FIG. 17, this step obtains the first node n1 (first winner, distance d1 from the piece of input data D(i)) that is closest to the piece of input data D(i) and the second node n2 (second winner, distance d2 from the piece of input data D(i)) that is second closest.

It is then determined whether the distance d1 from the piece of input data D(i) to the first winner (n1) is longer than a reference distance (step S03).

If the distance d1 is longer than the reference distance (YES at step S03), the piece of input data D(i) is updated to a node (step S04). Then, based on the winning node, n1 is updated to n2, D(i) is updated to n1, and n2 is updated to n3. Also, the path activation value is initialized (As (n1,:)=0).

As shown in part (b) of FIG. 17, a new first node n1 is created.

If the distance d1 is less than or equal to the reference distance (NO at step S03), the node positions and the path activation value are updated (step S05).

Specifically, as shown in part (c) of FIG. 17, activation values a1 and a2 are determined according to the distances between the piece of input data D(i) and each of the first and second nodes n1 and n2.

$$\vec{{n}_{1}} + = g \frac{{a}_{1}}{{a}_{1} + {a}_{2}} ( \vec{D ( l )} - \vec{{n}_{1}} ) \qquad [ Expression 16 ]$$

$$\vec{{n}_{2}} + = g \frac{{a}_{2}}{{a}_{1} + {a}_{2}} ( \vec{D ( l )} - \vec{{n}_{2}} )$$

Also, the node positions and the path activation value As (n1,n2) are updated as shown below (Hebb's rule).

$$As ( n 1 , n 2 ) += a 1 \times a 2 \qquad [ Expression 17 ]$$

If mod (i, designated interval)=0, the path with the lowest activation value is removed (step S06).

Then, it is determined whether to end the process (step S07). If i=M (YES at step S07), the online learning process ends. If i≠M (NO at step S07), “i=i+1” is set, and the process from step S02 is repeated.

Differences in effect between the ESOM and the present invention are described below.

For map 600 shown in FIG. 10, an ESOM is applied to two-dimensional data.

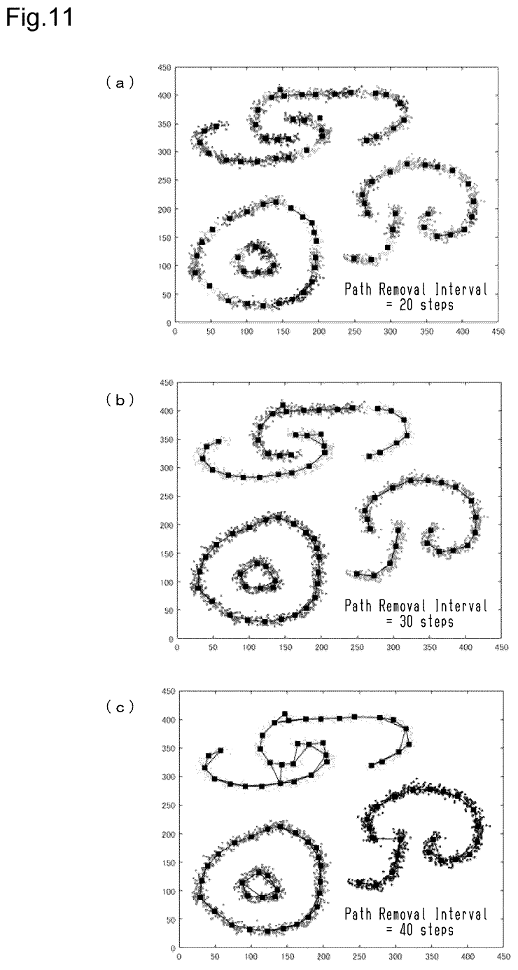

FIG. 11 shows the results of clustering performed in the ESOM while changing the path removal interval. In part (a) of FIG. 11, the path removal interval is 20 steps, in part (b) of FIG. 11, it is 30 steps, and in part (c) of FIG. 11, it is 40 steps. In this case, the results of clustering (gray density) are considerably different among parts (a) to (c) in FIG. 11 according to the removal interval. For this reason, it is difficult to determine an appropriate removal interval, necessitating trial and error.

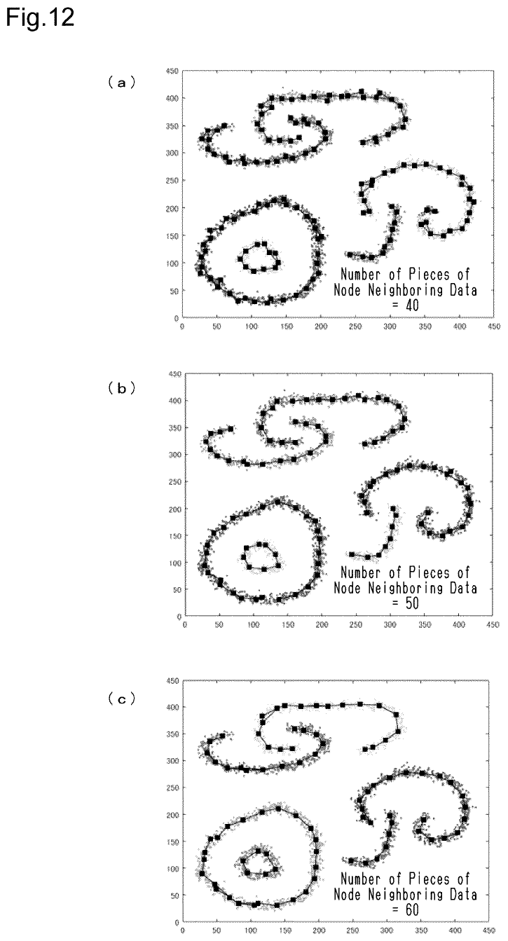

In FIG. 12, the number of pieces of node neighboring data is modified in the present invention. In part (a) of FIG. 12, the number of pieces of neighboring data is 40, in part (b) of FIG. 12, it is 50, and in part (c) of FIG. 12, it is 60. In this case, in clustering, similar results are obtained in any of the cases of parts (a) to (c) of FIG. 12. Thus, the parameters can be easily specified.

### Second Embodiment

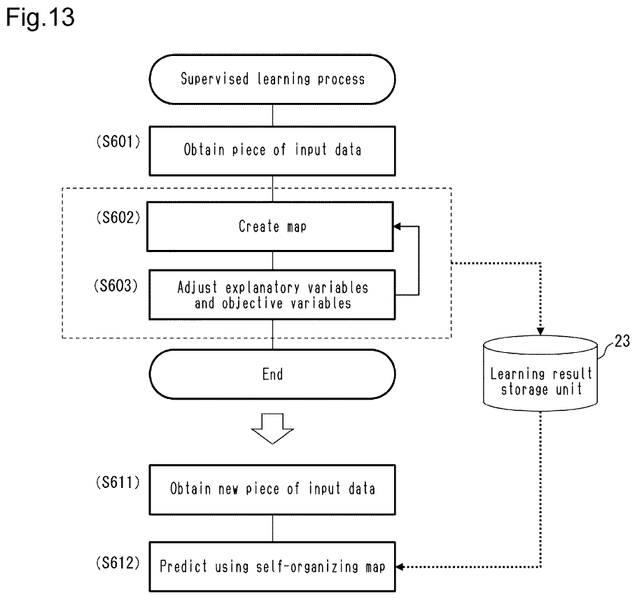

Referring to FIG. 13, a learning system, a learning method, and a learning program according to a second embodiment will now be described. In the first embodiment, unsupervised learning has been described. The second embodiment has a configuration obtained by modifying the first embodiment to adapt to supervised learning. In the following description of the second embodiment, same reference numerals are given to those that are the same as the first embodiment. Detailed descriptions of such configurations are omitted. The second embodiment creates a self-organizing map using a data set in which explanatory variables and objective variables are coupled during learning.

Referring to FIG. 13, a supervised learning process is now described.

First, the control unit 21 of the support server 20 performs processing of input data obtainment (step S601). Specifically, the learning unit 211 of the control unit 21 obtains piece of input data including explanatory variables and objective variables. Then, the learning unit 211 forms the input data by coupling variable values of explanatory variables and variable values of objective variables.

The control unit 21 of the support server 20 then performs a map creation process shown in FIG. 3 (step S602). The created map is recorded in the learning result storage unit 23.

The control unit 21 of the support server 20 then performs processing of adjusting explanatory variables and objective variables (step S603). Specifically, the learning unit 211 of the control unit 21 verifies the accuracy of the learning. When the accuracy of the learning has not reached the reference value, the learning unit 211 repeats the map creation process (step S602) by changing the tuning coefficient, which is a hyperparameter of the learning. This repetition performs cross-verification to search for an optimal value that causes the learning accuracy to be equal to or higher than the reference value. In this manner, the influence of the objective variable is adjusted by multiplying the variable value of the objective variable by the tuning coefficient.

In prediction, the control unit 21 of the support server 20 performs processing of obtaining a new piece of input data (step S611). Specifically, the obtainment unit 210 of the control unit 21 newly obtains a piece of input data including only variable values of explanatory variables from the user terminal 10.

The control unit 21 of the support server 20 then performs prediction processing using the self-organizing map (step S612). Specifically, the output unit 212 of the control unit 21 identifies the node that is closest to the variable values of the explanatory variables of the piece of input data. Then, the output unit 212 obtains the objective variable value of the identified node. Furthermore, the output unit 212 divides the objective variable value by the tuning coefficient.

The present embodiment has the following advantages in addition to advantages (1-1) to (1-6) described above.
(2-1) In this embodiment, the control unit 21 of the support server 20 performs processing of input data obtainment (step S601). Thus, a self-organizing map is created using piece of input data including objective variables and explanatory variables. The prediction can be made by calculating distances using the self-organizing map, increasing the interpretability of the prediction result.
(2-2) In the present embodiment, the control unit 21 of the support server 20 performs processing of adjusting explanatory variables and objective variables (step S602). This allows a self-organizing map to be created with the explanatory variables and objective variables balanced.

### Third Embodiment

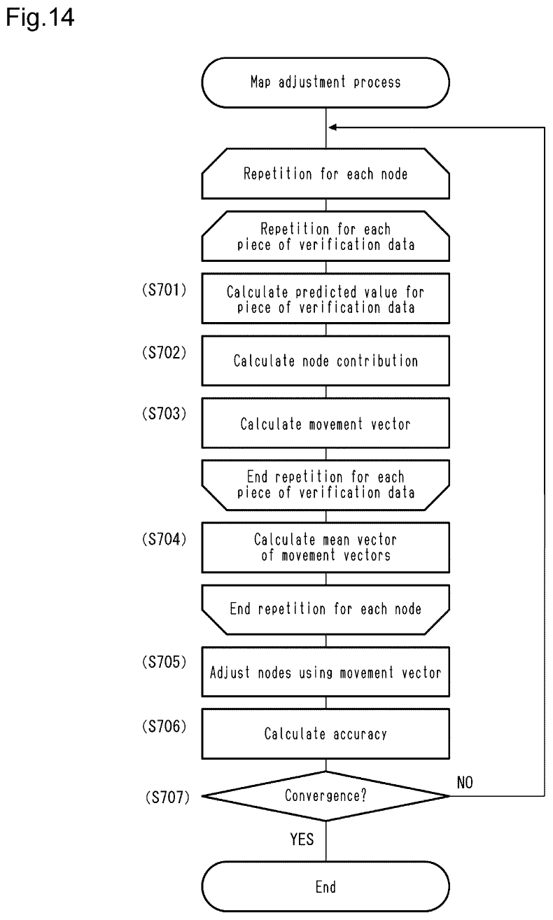

Referring to FIG. 14, a third embodiment of a learning system, a learning method, and a learning program is now described. In the second embodiment, supervised learning has been described. The third embodiment has a configuration obtained by modifying the second embodiment so as to adjust node positions using pieces of verification data. In the following description of the third embodiment, same reference numerals are given to those that are the same as the second embodiment. Detailed descriptions of such configurations are omitted. The third embodiment creates a self-organizing map by coupling explanatory variables and objective variables during learning.

For example, an example will now be discussed in which the first node n1 is predicted as a prediction result obtained using explanatory variable values of pieces of verification data. In this example, the objective variable value of the second node n2 is closer to the objective variable value (correct answer) of the piece of verification data than the objective variable value of the first node n1. In this case, by comparing the distances d (node contributions) of the explanatory variables in each dimension, the dimension that has a negative influence can be identified. As the verification data, data used to create the self-organizing map (training data) may be used, or data other than the training data (data intended only for verification) may be used.

Referring to FIG. 14, a map adjustment process is now described.

The following process is repeated for each node and each piece of verification data.

First, the control unit 21 of the support server 20 performs processing of calculating a predicted value of a piece of verification data (step S701). Specifically, the obtainment unit 210 of the control unit 21 inputs the explanatory variable values of the piece of verification data into the self-organizing map. The output unit 212 then identifies the node that is closest (closest node). Then, the output unit 212 obtains the objective variable value of the closest node as a predicted value.

The control unit 21 of the support server 20 then performs processing of calculating a node contribution (step S702). Specifically, the learning unit 211 of the control unit 21 calculates the node contribution dAi,j using the following difference.

$${dA}_{i , j} = \vert {dA}_{predict}^{j} - {dA}_{true}^{j} \vert - \vert {dA}_{predict wo i}^{j} - {dA}_{true}^{j} \vert \qquad [ Expression 18 ]$$

i: Node number
j: Data number concerning node i
   A_{predict}ⁱ: Predicted value of piece of data j
   Aₜᵣᵤₑⁱ: Correct answer of piece of data j
   A_{predict wet}ⁱ: Predicted value of piece of data j with node i removed

The control unit 21 of the support server 20 then performs movement vector calculation processing (step S703). Specifically, the learning unit 211 of the control unit 21 calculates the movement vector dVi,j by the following expression.

$$\vec{{dV}_{i , j}} = - {dA}_{i , j} ( \vec{{d}_{j}} - \vec{{n}_{i}} ) \qquad [ Expression 19 ]$$

The above process is repeated until all pieces of verification data are processed.

The control unit 21 of the support server 20 then performs processing of calculating the mean vector of the movement vectors (step S704). Specifically, the learning unit 211 of the control unit 21 obtains a movement vector (mean vector) dVi, mean by the following expression.

$${dV}_{i , mean} = {\sum }_{j} {dV}_{i , j} \qquad [ Expression 20 ]$$

The above process is repeated until all nodes are processed.

The control unit 21 of the support server 20 then performs processing of adjusting nodes using the movement vector (step S705). Specifically, the learning unit 211 of the control unit 21 moves the node using the movement vector dVi, mean multiplied by the tuning coefficient.

The control unit 21 of the support server 20 then performs processing of accuracy calculation (step S706). Specifically, the output unit 212 of the control unit 21 predicts the objective variable value by inputting the explanatory variables of the piece of verification data into the adjusted self-organizing map. The output unit 212 then calculates the proportion of correct prediction (accuracy) by comparing the predicted objective variable values and the objective variables of each of the verification data.

The control unit 21 of the support server 20 then performs processing of determining whether convergence has been achieved (step S707). Specifically, the learning unit 211 of the control unit 21 compares the accuracy of the previously created map with the accuracy of the currently created map. Then, if the accuracy has been improved, that is, if the accuracy of the currently created map is higher than the accuracy of the previously created map, it is determined that convergence has not been achieved. The convergence determination is not limited to determining whether accuracy has improved. For example, convergence may be determined when the accuracy improvement is within a predetermined range.

If it is determined that the accuracy has been improved, that is, convergence has not been achieved (NO at step S707), the control unit 21 of the support server 20 sets the accuracy of the currently created map as the initial accuracy, and repeats the process from step S701.

If it is determined that the accuracy has not been improved, that is, convergence is achieved (YES at step S707), the control unit 21 of the support server 20 ends the map adjustment process.

The present embodiment has the following advantages in addition to advantages (1-1) to (1-6), (2-1), and (2-2) described above.
(3-1) The control unit 21 of the support server 20 performs processing of node contribution calculation (step S702). This enables analysis of the cause of prediction failure based on the node contributions. In other words, based on the magnitude relationship between the distance between each piece of the verification data and the correct node and the distance between each piece of the verification data and the incorrect node in each dimension, a node that has a positive influence on the prediction and a node that has a negative influence on the prediction can be identified.
(3-2) In the present embodiment, the control unit 21 of the support server 20 then performs movement vector calculation processing (step S703). This allows the node that has caused the prediction failure to be moved, thereby improving the self-organizing map.

The present embodiment may be modified and implemented as follows. The embodiment and the following modifications may be combined to an extent that does not cause technical contradiction.

In the first embodiment described above, online learning processing is performed. However, it is not limited to online processing and any processing may be performed that creates a self-organizing map. For example, clustering may be performed using a self-organizing map created by batch processing.

In the first embodiment, the control unit 21 of the support server 20 performs processing of input data analysis (step S101). The maximum distance dmax is calculated. The maximum distance dmax may be any statistical value representing a piece of input data. There is no limitation on the method for calculating the maximum distance dmax. Alternatively, the initial value of the maximum distance dmax may be set in advance, and the maximum distance dmax may be recalculated as the number of pieces of input data increases.

In the second embodiment, the control unit 21 of the support server 20 performs prediction processing using a self-organizing map (step S612). Specifically, the output unit 212 of the control unit 21 identifies the node that is closest to the variable values of the explanatory variables of the pieces of input data. The objective variable may be predicted by regression using multiple nodes connected to the closest first node n1.

In this case, multiple nodes may be identified using other nodes that are connected to the closest first node n1 by paths.

In the third embodiment, a node position is adjusted using the node contribution (steps S702 to S705 in FIG. 14). Alternatively or additionally, a node position may be adjusted based on the contribution of the path. For example, an example will now be discussed in which the objective variable value of the second node n2 is closer to the objective variable value (correct answer) of each piece of verification data than the objective variable value of the first node n1 predicted using the explanatory variable values of the piece of verification data. In this case, by comparing the distances D of the explanatory variables in each dimension, the dimension that has a negative influence is identified. The map adjustment process is not limited to the method using Expression 18 (expression of node contribution dAi,j) in the third embodiment.

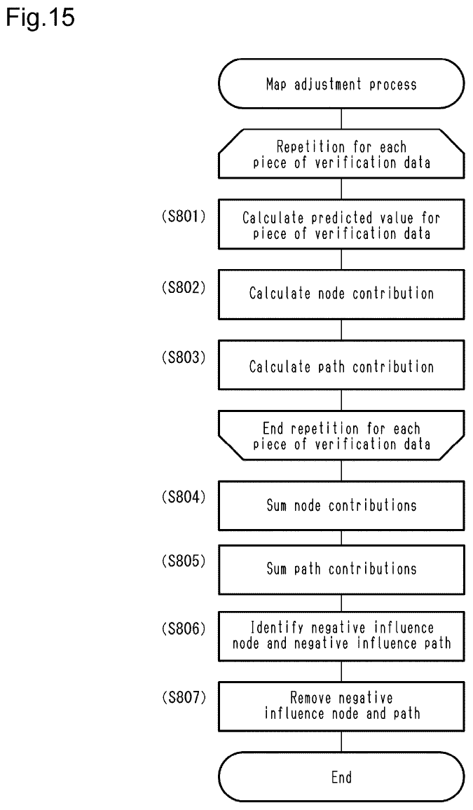

Referring to FIG. 15, another map adjustment process is now described.

The following process is repeated for each piece of verification data.

First, the control unit 21 of the support server 20 performs predicted value calculation processing on pieces of verification data, in the same manner as step S701 (step S801).

The control unit 21 of the support server 20 then performs processing of node contribution calculation (step S802), in the same manner as step S702.

The control unit 21 of the support server 20 then performs processing of path contribution calculation (step S803). Specifically, the learning unit 211 of the control unit 21 calculates the path contribution dAk,l (1 is a lowercase L) using the following difference.

$${dA}_{k , l} = \vert {dA}_{predict}^{l} - {dA}_{true}^{l} \vert - \vert {dA}_{predict wo k}^{l} - {dA}_{true}^{l} \vert \qquad [ Expression 21 ]$$

k: Node number
L: Data number concerning node k
   A_{predict}ⁱ: Predicted value of piece of data 1
   Aₜᵣᵤₑⁱ: Correct answer of piece of data I
   a_{predict wok}ⁱ: Predicted value of piece of data I with node k removed

The above process is repeated until all pieces of verification data are processed.

The control unit 21 of the support server 20 then performs processing of summing the contributions of the nodes (step S804). Specifically, the learning unit 211 of the control unit 21 calculates the total contribution dASi of the nodes using by following expression.

$$d A {S}_{i} = {\sum }_{j} d {A}_{i . j} \qquad [ Expression 22 ]$$

The control unit 21 of the support server 20 then performs the step of summing the path contributions (step S805). Specifically, the learning unit 211 of the control unit 21 calculates the total path contributions dASk by the following expression.

$$d A {S}_{k} = {\sum }_{l} d {A}_{k , l} \qquad [ Expression 23 ]$$

The control unit 21 of the support server 20 then performs processing of identifying nodes having a negative influence and paths having a negative influence (step S806). Specifically, the learning unit 211 of the control unit 21 sorts the total node contributions dASi and the total path contributions dASk separately in descending order. Then, the learning unit 211 identifies the nodes and paths corresponding to the predetermined numbers of dASi and dASk from the top as negative influence nodes and negative influence paths.

The control unit 21 of the support server 20 then performs processing of removing negative influence nodes and negative influence paths (step S807). Specifically, the learning unit 211 of the control unit 21 removes the identified negative influence nodes and negative influence paths.

When a total node contribution dASi is positive, or a total path contribution dASk is positive, the corresponding node or path is likely to have a negative influence on the prediction. Thus. node or paths having negative influences can be removed according to node contributions and path contributions.

1. A learning system comprising control circuitry that creates a self-organizing map, wherein the control circuitry is configured to:
identify a neighboring node for a piece of input data among existing nodes;
calculate a distance between the piece of input data and the neighboring node;
when the distance is greater than a maximum distance, add a new node to the existing nodes using the piece of input data and update activation values and ages of the new node and the neighboring node in accordance with the distance to the neighboring node;
when the distance is less than or equal to the maximum distance, update a position, an activation value, and an age of the neighboring node in accordance with the distance between the piece of input data and the neighboring node; and
calculate an activation rate from the age using an activation value of each node and an activation value of each path and create the self-organizing map by determining presence or absence of each node and each path in accordance with the calculated activation rate.

2. The learning system according to claim 1, wherein the control circuitry is configured to:
identify a predetermined number of distances between each piece of element data and other pieces of element data of the piece of input data in ascending order of distance; and
calculate the maximum distance based on a statistical value of the identified distances.

3. The learning system according to claim 2, wherein the control circuitry is configured to:
using each piece of element data of the piece of input data, sequentially identify another piece of element data whose distance is less than the maximum distance;
calculate an activation value and an age of each piece of element data in accordance with a distance between each piece of element data and the other piece of element data; and
calculate an activation rate from an activation value and the age of each node and determine the initial existing nodes in accordance with the calculated activation rate.

4. The learning system according to claim 1, wherein the control circuitry is configured to use, as the piece of input data, a data set in which explanatory variable values and objective variable values are combined.

5. The learning system according to claim 4, wherein the control circuitry is configured to:
predict an explanatory variable value of a node corresponding to an explanatory variable value of a piece of verification data in a self-organizing map created using the piece of input data; and
move a node that is included in the self-organizing map in accordance with a difference between the explanatory variable value of the piece of verification data and the predicted explanatory variable value.

6. The learning system according to claim 4, wherein the control circuitry is configured to:
predict an explanatory variable value in accordance with a contribution of each node corresponding to an explanatory variable value of a piece of verification data in a self-organizing map created using the piece of input data; and
move a node of the self-organizing map in accordance with a difference between the explanatory variable value of the piece of verification data and the predicted explanatory variable value.

7. The learning system according to claim 4, wherein the control circuitry is configured to:
predict an explanatory variable value in accordance with a contribution of each node and each path corresponding to an explanatory variable value of piece of verification data in a self-organizing map created using the piece of input data; and
remove the node and the path depending on the contribution of the node and the path.

8. A learning method for creating a self-organizing map using a learning system including control circuitry, the learning method comprising causing the control circuitry to:
identify a neighboring node for a piece of input data among existing nodes;
calculate a distance between the piece of input data and the neighboring node;
when the distance is greater than a maximum distance, add a new node to the existing nodes using the piece of input data and updating activation values and ages of the new node and the neighboring node in accordance with the distance to the neighboring node;
when the distance is less than or equal to the maximum distance, update a position, an activation value, and an age of the neighboring node in accordance with the distance between the piece of input data and the neighboring node; and
calculate an activation rate from the age using an activation value of each node and an activation value of each path and creating the self-organizing map by determining presence or absence of each node and each path in accordance with the calculated activation rate.

9. A non-transitory computer-readable storage medium that stores a learning program for creating a self-organizing map using a learning system including control circuitry, the learning program being configured to cause the control circuitry to perform operations comprising:
identifying a neighboring node for a piece of input data among existing nodes;
calculating a distance between the piece of input data and the neighboring node;
when the distance is greater than a maximum distance, adding a new node to the existing nodes using the piece of input data and updates activation values and ages of the new node and the neighboring node in accordance with the distance to the neighboring node;
when the distance is less than or equal to the maximum distance, updating a position, an activation value, and an age of the neighboring node in accordance with the distance between the piece of input data and the neighboring node; and
calculating an activation rate from the age using an activation value of each node and an activation value of each path and creating the self-organizing map by determining presence or absence of each node and each path in accordance with the calculated activation rate.
